(19) United States
(12) Patent Application Publication
(10) Pub. No.: US 2005/0015635 A1
(43) Pub. Date: Jan. 20, 2005

(54) POWER CONTROL SYSTEM FOR PROVIDING DIFFERENT OUTPUT VOLTAGES BASED ON OPERATION STATES OF COMPUTER SYSTEM

(76) Inventor: Kuan-Chi Juan, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,504

(22) Filed: Oct. 3, 2003

(30) Foreign Application Priority Data
Jul. 17, 2003 (TW) 092119570

(51) Int. Cl. G06F 1/26

(52) U.S. Cl. 713/323

(57) ABSTRACT

A power control system used in a computer system includes decision logic for outputting a decision voltage based on detection of an operational state of the computer system. The power control system includes a voltage control unit, having at least two resistors and a switch, for outputting a set voltage based on an on and off state of the switch determined by the decision voltage. A power supply circuit provides an output voltage to the computer system based on the set voltage.

### BACKGROUND OF INVENTION

1. Field of the Invention

The invention relates to a power control system used in a computer system, and more particularly, to a power control system that can provide various operating voltages to the computer system according to different states of the computer system.

2. Description of the Prior Art

With the rapid development of information technology, computer systems play important roles in modernizing many companies and are widely used in practically every industry. Consequently, the manufacturing of portable computers, including PDAs and notebooks, has become a mainstream business in the computer industry. In order to utilize the portable computer systems without an external power supply, users require batteries to provide sufficient power to the computer system. However, the power stored in the battery is exhaustible, and the operating time of the computer system is limited by the power capacity of the battery. Therefore, how to increase the time for which the battery provides electricity for the computer system has become a critical issue.

Please refer to FIG. 1, which is a functional block diagram of a computer system 10 according to the prior art. The computer system 10 includes a processor 12, a power supply circuit 14, a battery 16, and a voltage unit 18. The processor 12 is used for controlling operations of the computer system 10 and the battery 16 is used for providing a stable DC voltage Vin. The battery 16 can also be used to output a set voltage Vset to the power supply circuit 14 through two resistors R1, R2 of the voltage unit 18. Therefore, the set voltage Vset is equal to the DC voltage Vin multiplied by a constant of R2/(R1+R2). The power supply circuit 14 is used to output an operating voltage Vout to the processor 12 and other circuitry of the computer system 10 according to the set voltage Vset. The higher the set voltage Vset, the higher the outputted operating voltage Vout is.

When the computer system is used for entertaining purposes, playing a DVD/VCD, or operating in an idle state, the computer system 10 is in a light-loaded state. On the other hand, the computer system 10 can also be in a heavy-load state, such as playing 3D images. Please refer to FIG. 2 and FIG. 3. FIG. 2 is a voltage variation diagram of the processor 12 when the prior-art computer system 10 is in the heavy-load state, and FIG. 3 is a voltage variation diagram of the processor 12 when the prior-art computer system 10 is in the light-load state. Please notice that although FIG. 2 and FIG. 3 only show the voltage variation of the processor 12, FIG. 2 and FIG. 3 can represent the voltage variations of other circuitries in the computer system 10 because the voltage variations of other circuitries in the computer system 10 are similar to those of the processor 12 in both the light-load state and the heavy-load state.

Generally, the operating voltage of the processor 12 is not a fixed value, operating at around 3.3 Volts (+/−10%). In other words, the processor 12 and other circuitries of the computer system 10 can operate normally when the corresponding operating voltages are higher than 3V. As shown in FIG. 2, the operating voltage of the processor 12 varies volatilely ALAllen Lu Please change the word to “volatilely”.in the heavy-load state and sometimes the operating voltage may reach the lower limit of the operating voltage, 3.0V. On the other hand, the operating voltage of the processor 12 varies slimly ALAllen Lu Please change the word to “slimly”.in the light-load state, and the operating voltage remains at a standard voltage value of 3.3V.

Please refer to FIG. 1. The battery 16 can be used to provide the stable DC voltage Vin and the voltage unit 18 can be used to output the set voltage Vset (=Vin*R2/(R1+R2)). The set voltage Vset may affect the outputted operating voltage Vout. Moreover, regarding the prior-art computer system 10, the set voltage remains unchanged either in the light-load state or in the heavy-load state, and the outputted operating voltage Voutcausally remains unchanged.

For the computer system 10 to operate normally in the heavy-load state, the set voltage has to remain at a larger voltage value to achieve greater operating voltage Vout. The above-mentioned approach, which maintains the computer system 10 operating normally in the heavy-load state, lacks ALAllen Lu Please replace “is lacking in” to “lacks”.flexibility. Moreover, the above-mentioned approach will lead to a power waste of the battery because the computer system 10 still has to be provided with a large operating voltage Vout in the light-load state.

### SUMMARY OF INVENTION

It is therefore a primary objective of the claimed invention to provide a power control system that can provide various operating voltages to the computer system according to different states of the computer system to solve the above-mentioned problems.

According to the claimed invention, a power control system used in a computer system is disclosed. The power control system includes a decision logic for detecting states of the computer system to output a decision voltage and a voltage control unit for outputting a set voltage according to the decision voltage outputted from the decision logic.

The voltage control unit includes a first resistor electrically connected to a voltage source, a second resistor electrically connected to the first resistor in series connection, and a switch circuit electrically connected to the first resistor in parallel connection and electrically connected to the decision logic. The switch circuit turns on or turns off according to the decision voltage outputted from the decision logic so that the voltage control unit can output the set voltage. The power control system further comprises a power supply circuit for generating an output voltage for the computer system according to the set voltage.

An advantage of the claimed invention is that the voltage control unit can determine various states of the computer system according to the decision voltage of the decision logic, and can provide various operating voltages to the computer system according to the different states of the computer system, so that a waste of the battery power can be avoided in the light-load state, and an increase of the time by which the battery provides electricity for the computer system can be achieved.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a computer system according to the prior art.

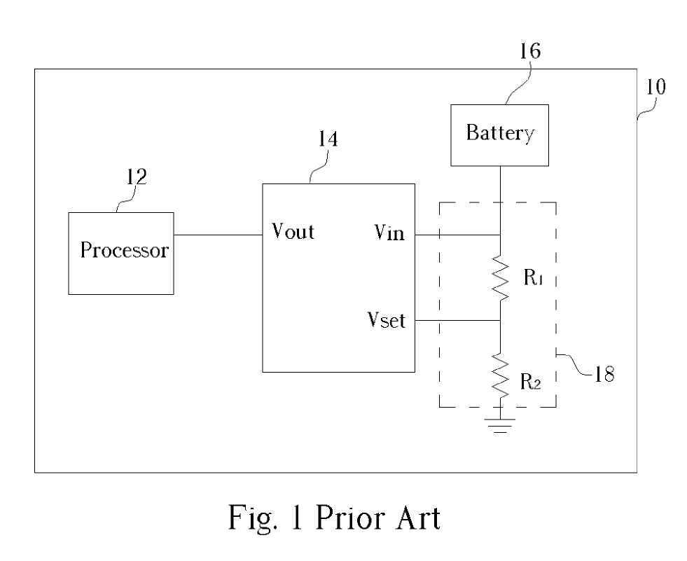

FIG. 2 is a voltage variation diagram of a processor in the heavy-load state.

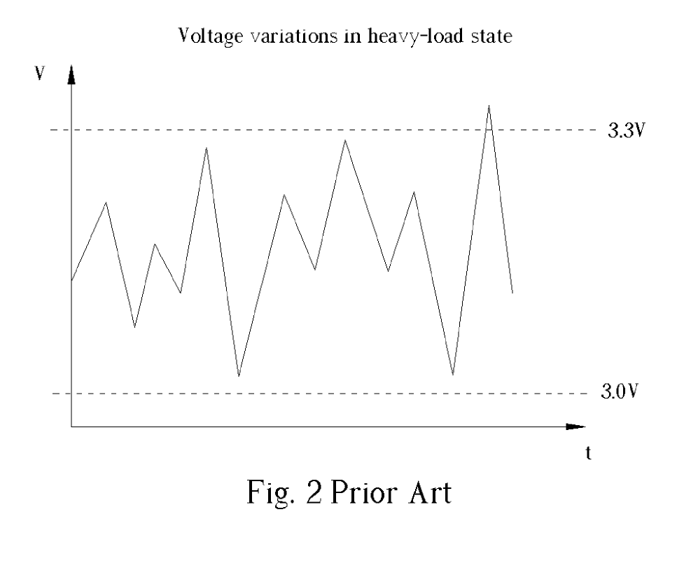

FIG. 3 is a voltage variation diagram of the processor in the light-load state.

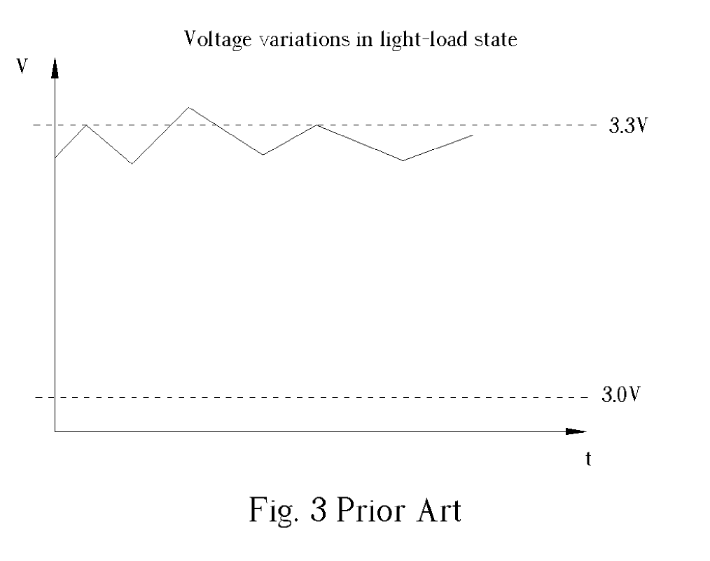

FIG. 4 is a functional block diagram of a first embodiment of a computer system according to the present invention.

FIG. 5 is a diagram showing a detecting signal outputted by a south bridge chip in a heavy-load state.

FIG. 6 is a diagram showing another detecting signal outputted by a south bridge chip in a light-load state.

FIG. 7 is a diagram showing both the DC detecting voltage and the reference voltage respectively in a light-load state and in a heavy-load state.

FIG. 8 is a functional block diagram of another computer system according to the present invention.

FIG. 9 is a functional block diagram of another computer system according to the present invention.

### DETAILED DESCRIPTION

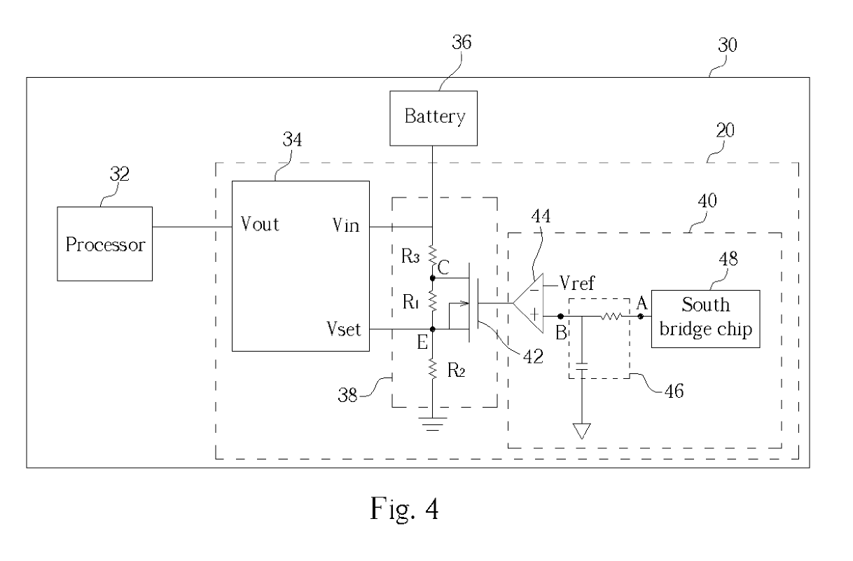

Please refer to FIG. 4, which is a functional block diagram of a first embodiment of a computer system 30 according to the present invention. The computer system 30 includes a processor 32, a battery 36, and a power control system 20. The power control system 20 includes a power supply circuit 34, a voltage control unit 38, and a decision logic 40.

The processor 32 is used for controlling operations of the computer system 30, and the battery 36 is used for providing a DC voltage for operating the computer system 30. The decision logic 40 is used for detecting states of the computer system 30 to output a decision voltage. The voltage control unit 38 is used to output a set voltage according to the decision voltage outputted from the decision logic 40. The power supply circuit 34 is used to generate an output voltage for electric components of the computer system 30 according to the set voltage. Because the processor 32 occupies a large proportion of power consumption in the computer system 30, the present embodiment takes the processor 32 as an example to describe the characteristics of the present invention.

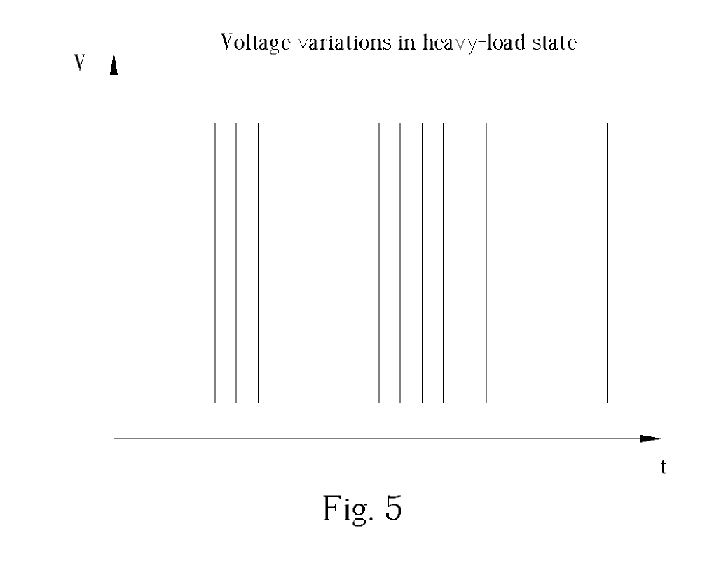

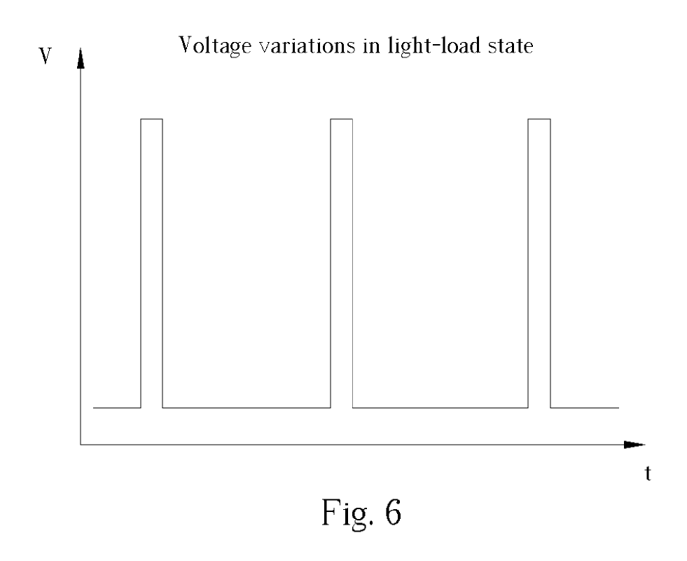

The decision logic 40 includes a south bridge chip 48, a comparator 44, and a voltage converter 46. Please refer to both FIG. 5 and FIG. 6. FIG. 5 is a diagram showing a detecting signal outputted by the south bridge chip 48 when the computer system 30 is in a heavy-load state, and FIG. 6 is a diagram showing another detecting signal outputted by the south bridge chip 48 when the computer system 30 is in a light-load state. A difference between the detecting signal at a node A (outputted by the south bridge chip 48) in the light-load state and the detecting signal at the node A in the heavy-load state can be realized by comparing FIG. 5 with FIG. 6.

The voltage converter 46 can be used to convert the detecting signal at the node A into a DC detecting voltage, and the voltage converter 46 can be implemented by an RC filter composed of a resistor and a capacitor. The generated DC detecting voltage will be compared with a reference voltage in the comparator 44.

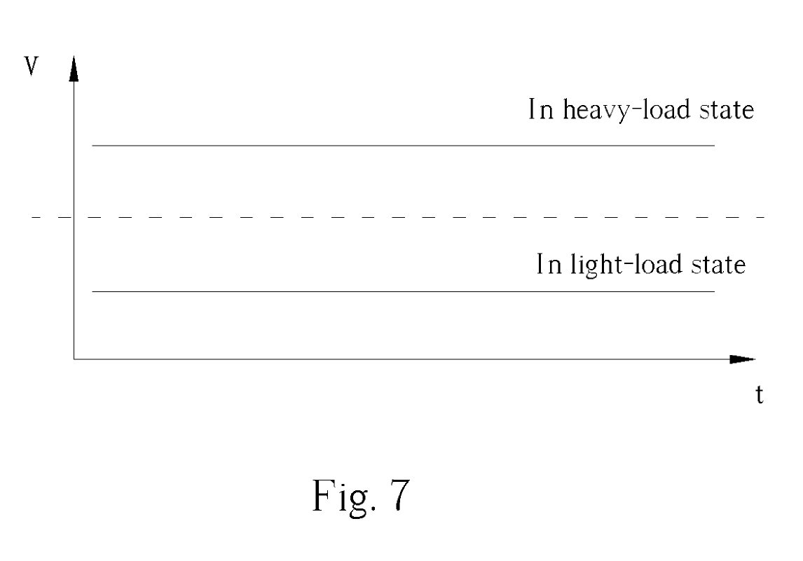

Please refer to FIG. 7, which is a diagram showing both the DC detecting voltage at the node B (outputted by the voltage converter 46) and the reference voltage respectively in the light-load state and in the heavy-load state in the computer system 30. As shown in FIG. 7, if a proper reference voltageVref is determined, the comparator 44 can output the decision voltage of a logic “1” in the heavy-load state. On the other hand, the comparator 44 can output the decision voltage of a logic “0” in the light-load state.

Please return to refer to FIG. 4. The voltage control unit 38 includes a first resistor R1, a second resistor R2, a third resistor R3, and a switch circuit 42. The switch circuit 42 can be an NMOS transistor. As shown in FIG. 4, the drain of the NMOS transistor 42 is electrically connected to the first resistor R1 and the third resistor R3 at a node C. The source of the NMOS transistor 42 is electrically connected to the first resistor R1 and the second resistor R2 at a node E. The gate of the NMOS transistor 42 is electrically connected to the comparator 44 for receiving the decision voltage outputted from comparator 44.

When the decision voltage of the comparator 44 is a logic “1”, the decision logic 40 will determine that the computer system 30 is operating in the heavy-load state, and the NMOS transistor 42 will conduct. Then the first resistor R1 can be neglected, and the set voltage Vset is equal to a value of Vin*R2/(R2+R3). On the other hand, when the decision voltage of the comparator 44 is a logic “0”, the decision logic 40 will determine that the computer system 30 is operating in the light-load state, and the NMOS transistor 42 will not conduct. Therefore, the set voltage Vset is equal to a value of Vin*R2/(R1+R2+R3).

Obviously, the set voltage Vset is smaller in the light-load state than that in the heavy-load state. The power supply circuit 34 can be used to process various set voltages Vsets to generate various output voltages for the computer system 30. Designers can properly control the value of the first resistor R1 via the above-mentioned controlling method.

On the premise that the output voltage Vout will not be affected in the heavy-load state, the output voltage Vout can be reduced in the light-load state. For instance, after selecting the proper first resistor R1, the set voltage Vset(=Vin*R2/(R2+R3)) in the heavy-load state can be controlled to generate the output voltage Vout of 3.3V through the power supply circuit 34. The set voltage Vset(=Vin*R2/(R1+R2+R3)) in the light-load state can be used to generate the output voltage Vout of 3.0V through the power supply circuit 34. Therefore, the power control system 20 can be used to reduce the operating voltage to the value of 3.0V in the light-load state instead of 3.3V, so that the computer system 30 can save the power when operating in the light-load state to efficiently utilize the battery 36.

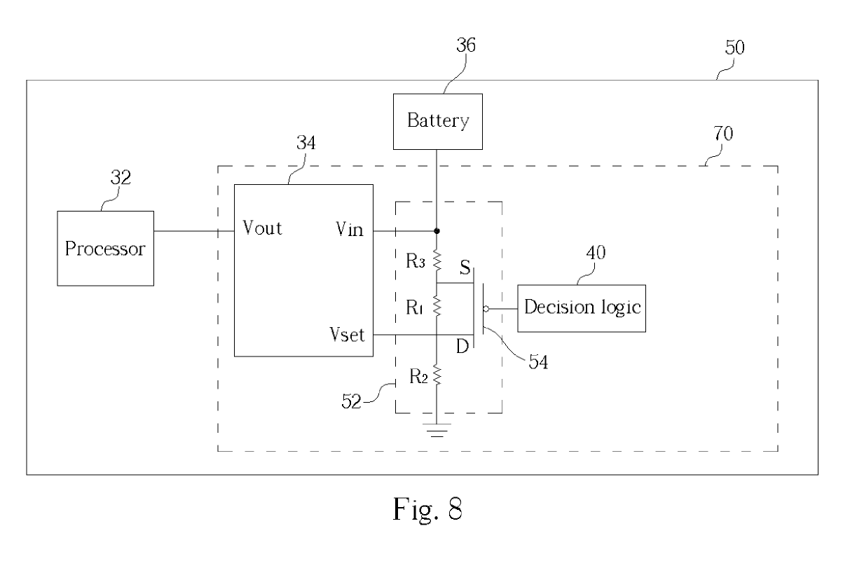

Please refer to FIG. 8, which is a functional block diagram of a second embodiment of a computer system 50 according to the present invention. The present embodiment inherits the characteristics of the embodiment shown in FIG. 4. However, the power control system 70 of the computer system 50 shown in FIG. 8 is slightly different from that shown in FIG. 4 (the power control system 20 of the computer system 30). The switch circuit 54 of the voltage control unit 52 is a PMOS transistor instead of an NMOS transistor.

When the decision voltage outputted from the decision logic 40 is a logic “0”, the switch circuit 54 will conduct. Therefore, the set voltage Vset is equal to the value of Vin*R2/(R2+R3). When the decision voltage outputted form the decision logic 40 is a logic “1”, the switch circuit 54 will turn off. Therefore, the set voltage Vset is equal to the value of Vin*R2/(R1+R2+R3). That is, if the decision logic 40 is designed to output the decision voltage of a logic “1” in the light-load state and to output the decision voltage of a logic “0” in the heavy-load state, the computer system 50 can significantly save the power when operating in the light-load state to efficiently utilize the battery 36.

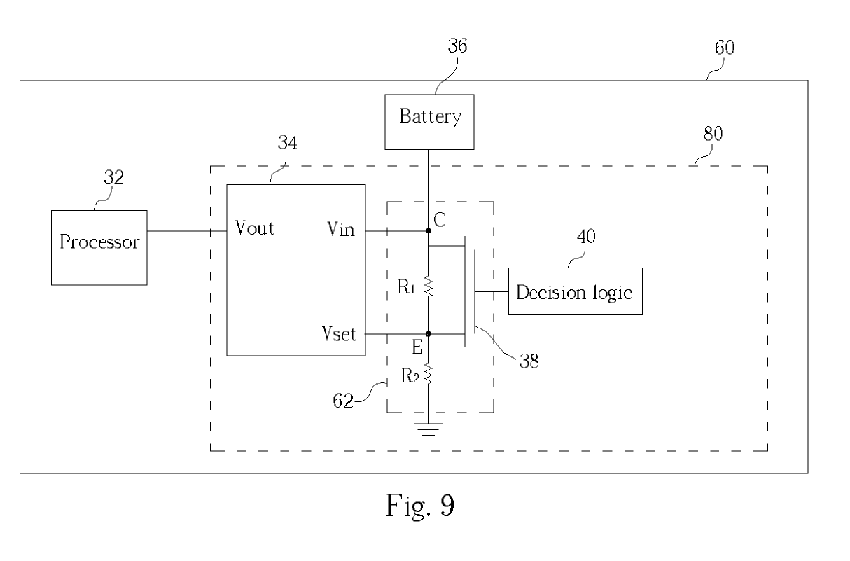

When being implemented, the third resistor R3 shown in FIG. 4 and FIG. 8 can be neglected. Please refer to FIG. 9, which is a functional block diagram of a third embodiment of a computer system 60 according to the present invention. The present embodiment also inherits the characteristics of the embodiment shown in FIG. 4. However, the power control system 80 of the computer system 60 shown in FIG. 9 is slightly different from that shown in FIG. 4 (the power control system 20 of the computer system 30). The power control system 80 does not include the third resistor R3 of the computer system 30 shown in FIG. 4. That is, the node C is directly electrically connected to the battery 36. Therefore, the voltage control unit 62 shown in FIG. 9 includes a first resistor R1, a second resistor R2, and a switch circuit 42. The switch circuit 42 can be an NMOS transistor or a PMOS transistor. In the present embodiment, the switch circuit 42 is implemented with an NMOS transistor.

In the heavy-load state, the conducted NMOS transistor 42 allows the set voltage Vset to become the value of Vin*R2/R2 (=Vin). In the light-load state, the turned-off NMOS transistor 42 allows the set voltage Vset to become the value of Vin*R2/(R1+R2). In addition, by changing some related settings of the power supply circuit 34, the output voltage Vout can be outputted in various values according to different set voltages Vset.

Please notice that the decision logic of the present invention can output the decision voltage via a current reader, a program code, or other devices that can be used to determine whether the computer system is in the light-load state or in the heavy-load state.

In contrast to the prior-art techniques, the power control system of the present invention can provide various operating voltages to the computer system according to different states of the computer system. In other words, when the computer system is in the light-load state, the power control system can output a lower operating voltage for the operating voltages of the electric components in the computer system operate at around 3.0 Volts (+/−10%) without large fluctuations in the light-load state. Therefore, the computer system of the present invention can normally operate with a lower operating voltage in the light-load state without the need of excess cost.

Those skilled in the art will readily observe that numerous modifications and alterations of the device and method may be made while retaining the teachings of the invention. Accordingly, the above disclosure should be construed as limited only by the metes and bounds of the appended claims.

1. A power control system used in a computer system, the power control system comprising:
a decision logic for detecting states of the computer system to output a decision voltage;
a voltage control unit for outputting a set voltage according to the decision voltage outputted from the decision logic, the voltage control unit comprising:
a first resistor electrically connected to a voltage source;
a second resistor electrically connected to the first resistor in series connection; and
a switch circuit electrically connected to the first resistor in parallel connection and electrically connected to the decision logic, wherein the switch circuit turns on or turns off according to the decision voltage outputted from the decision logic so that the voltage control unit can output the set voltage; and
a power supply circuit for generating an output voltage for the computer system according to the set voltage.

2. The power control system of claim 1 wherein the decision logic comprises:
a south bridge chip for outputting a detecting signal according to states of the computer system;
a voltage converter for converting the detecting signal into a detecting voltage, the voltage converter comprising a resistor and a capacitor; and
a comparator for comparing the detecting voltage with a reference voltage to output the decision voltage.

3. The power control system of claim 1 wherein the decision logic comprises a current reader for outputting the decision voltage according to states of the computer system.

4. The power control system of claim 1 wherein the decision logic comprises a program code stored in a memory for outputting the decision voltage according to states of the computer system.

5. The power control system of claim 1 wherein the switch circuit is a PMOS transistor; when the decision voltage outputted from the decision logic is at a low voltage level, the switch circuit conducts; when the decision voltage outputted from the decision logic is at a high voltage level, the switch circuit turns off.

6. The power control system of claim 1 wherein the switch circuit is an NMOS transistor; when the decision voltage outputted from the decision logic is at a low voltage level, the switch circuit turns off; when the decision voltage outputted from the decision logic is at a high voltage level, the switch circuit conducts.

7. The power control system of claim 1 wherein the voltage control unit further comprises a third resistor electrically connected between the first resistor and the voltage source.

8. The power control system of claim 1 wherein the voltage source is a battery.

9. The power control system of claim 1 wherein the computer system is a notebook or a personal digital assistant (PDA).
